(19) United States
(12) Patent Application Publication
(10) Pub. No.: US 2008/0170828 A1
(43) Pub. Date: Jul. 17, 2008

(54) Indoor cable assemblies with flexible network access point

(76) Inventors: Robert Bruce Elkins, Hickory, NC (US); Samuel Don Nave, Newton, NC (US); Donald Kennedy Hall, Mooresville, NC (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/652,721

(22) Filed: Jan. 12, 2007

(51) Int. Cl. G02B 6/255; G02B 6/02

(52) U.S. Cl. 385/95; 427/163.2

(57) ABSTRACT

An indoor fiber optic cable assembly comprising a flame retardant fiber optic distribution cable comprising at least one network access point at which at least one optical fiber is preterminated, a flame retardant flexible closure substantially enclosing the at least one network access point, and at least one tether secured about the flexible closure and comprising at least one optical fiber within that is optically connected with the at least one preterminated optical fiber of the distribution cable. The flexible closure may be overmolded or a heat shrink and the cable and closure are riser, plenum or low smoke zero halogen rated, among others. Tethers may be splice ready, connectorized or terminate in a multi-port connection terminal.

### BACKGROUND OF THE INVENTION

1. Field of the Invention

The present invention relates generally to cable assemblies including flexible network access points, and more specifically, to cable assemblies for indoor applications including flexible network access points and the performance and material properties of such cable assemblies.

2. Technical Background

Optical fiber is increasingly being used for a variety of broadband communications including voice, video and data transmissions. As a result of the increasing demand for broadband communications, fiber optic networks typically include distribution cables having network access points (NAPs), also referred to herein as “mid-span access locations” or “tap points,” at which at least one optical fiber is preterminated, branched and spliced or otherwise optically connected to at least one optical fiber of a tether or drop cable. NAPs may be used to provide a number of branches off of the distribution cable and are being used to extend optical networks to an increasing number of subscribers. Such fiber optic networks are commonly referred to as “FTTx” networks, where “FTT” stands for “Fiber-to-the” and “x” generically describes an end location.

While there has been an increase in the development of outdoor cable assemblies that satisfy outdoor installation and environmental requirements, there is a need for cable assembly solutions for indoor applications and environments, for example, multi-dwelling unit (MDU) applications. Based on the potentially large number of branch points needed to satisfy MDU demand, and the installation and performance requirements of cable assemblies installed within indoor environments, there is a need for indoor cable assemblies that not only provide an adequate number of network access points, but are also flexible to indoor installation environments and meet indoor performance requirements, such as flame retardant requirements. Desirable indoor cable assemblies should further maintain and protect the optical fibers, splice points and accessed portions of the cable assemblies and may also be deployed in outdoor environments as well.

### SUMMARY OF THE INVENTION

In various embodiments, the present invention provides indoor/outdoor, factory and field prepared cable assemblies that include at least one flexible network access point for presenting at least one preterminated and spliced optical fiber through a tether or drop cable that may or may not be connectorized. In various embodiments, the present invention provides cable assemblies including flexible network access points that may be used to provide services within a MDU or any other installation environment.

In various embodiments, the present invention provides indoor cable assemblies including flame retardant cables and NAPs that meet or exceed the UL1666 flame test for riser applications, a test for flame propagation height of electrical and optical fiber cables installed vertically in shafts. In various other embodiments, the present invention provides indoor cable assemblies including flame retardant cables and NAPs that meet or exceed the NFPA 262 flame test, the standard method of test for flame travel and smoke of wires and cables for use in air-handling spaces. In one embodiment, the cable assemblies include OFNR (optical fiber non-conductive riser) interior cables and NAPs that do not contain electrically conductive components and which are certified for use in riser applications to prevent the spread of fire from floor to floor in an MDU and are ANSI/UL 1666-1997 compliant. In another embodiment, the cable assemblies include plenum cable that is laid in the plenum spaces of buildings typically used for air circulation in heating and air conditioning systems, typically between the structural ceiling and the dropped ceiling or under a raised floor. The plenum cables and their respective NAPs of the present invention meet or exceed the NFPA 90A standard, the standard for the installation of air conditioning and ventilating systems. Cable assemblies that are run between floors in non-plenum areas are rated as riser cable, fire requirements on riser cable being less strict than plenum. In yet another embodiment, the cable assemblies may include cables and NAPs that are LSZH (low smoke zero halogen) compliant and do not produce a Halogen gas when burned. In the various embodiments, being flame retardant may apply to various specifications such as riser or plenum, LSZH, etc. and may be subject to various standards, for example, UL1666, 94, 2043, IEC 61034, etc.

In other embodiments, the present invention provides various fiber optic distribution cables having at least one flexible NAP comprised of an overmolded or heat-shrink portion for substantially sealing and protecting an access location of a pre-engineered cable assembly. The access location provides access to one or more optical fibers within the distribution cable for pretermination. The flexible NAP portion of an assembly is capable of bending to about the minimum bend radius of the fiber optic cable upon which the flexible NAP is installed. The flexible NAP portion can be bent with a force about equal to the force required to bend the cable itself without the flexible NAP attached. The bending range of the flexible Nap portion is from about 0 degrees to about 360 degrees, allowing the flexible NAP portion to be bent about a radius, twisted, and bent in S-shaped, U-shaped or complex arcs. The flexible Nap portion can be bent and/or twisted in virtually any direction. In some embodiments, the flexible NAP portion has a preferential bend, yet it is flexible and twistable. The flexible NAP portion of a cable assembly has an outer diameter equal to or slightly larger than the cable to which it is attached, thus facilitating installation within indoor environments, for example, over installation pulleys and other installation equipment or hardware, or through conduit. Further, the flexible NAP portion has a diametral ratio (ratio of the at least one overmold portion outer diameter to the cable outer diameter) from about 1.0 to about 5.0, preferably about 2.0. In other embodiments, the flexible NAP portion has an aspect ratio (ratio of the length of the flexible closure to the outer diameter of the flexible closure) from about 2 to about 30.

In other embodiments, intrinsic material properties of the overmolded or heat shrink portion contribute to the flexible, yet sturdy, characteristic of the flexible NAP portion. The intrinsic properties may also contribute to the flame retardency of the overmolded of heat shrink portion. An overmolded portion may be formed by pour molding, high-pressure molding, injection molding, among others, by providing a flowable material about the cable access point, substantially encapsulating components and allowing the material to cure to define a flexible yet durable closure about the components. In various embodiments, the flexible NAP internal components can include various optical network components, taken alone or in combination, for example: one or more optical fibers, splices, splice holders, optical connectors, jumpers, fanouts, buffer or fanout tubes, strength members, splitters, active optical components such as switches, lasers, and routers, wireless components, antennae, electrical/copper connector cables, RFID tags, power devices or any other desired optical and electrical hardware or cable components.

In yet another embodiment, the flexible NAP portion may have a bending force ratio from about 1.0 to about 10.0, more preferably from about 1.0 to about 5.0. The bending force ratio is defined as the ratio of a first force to a second force: first, the force required to bend a flexible closure (with optical components therein) about 90 degrees around a pre-selected minimum bend radius of the fiber optic cable, as for example, defined by a mandrel; and second, the force required to bend the same fiber optic cable about 90 degrees about the pre-selected minimum bend radius of that same cable without the closure attached to the cable. In preferred embodiments, the flexible NAP has a bending force ratio of about 1.0, thus the force required to bend the NAP is about equivalent to the force required to bend that same fiber optic cable at a point or portion without the NAP. In various embodiments, the NAPs have an outer diameter of about 0.5 to about 5 inches. Diametral ratios of about 3.0 or less are preferred, while ratios of about 2.0 or less are more preferred. Aspect ratios ranging from about 2 to about 30 are preferred. An intrinsic property of the material comprising the flexible NAP preferably provides a modulus of elasticity of up to about 3.0 GPa, with a preferred range of about 0.001 to about 0.1 GPa, and an even more preferred modulus of elasticity of about 0.044 GPa. The overmolded bodies preferably have a Poisson's ratio from about 0 to about 0.5, more preferably about 0.2 to about 0.5, even more preferably from about 0.30 to about 0.5.

In yet another aspect, the present invention provides various embodiments of factory manufactured cable assemblies having predetermined NAPs that also serve as tether attach points. A NAP point may include one or more tethers and the tethers are used to extend the network to a location within reach of tether. In an MDU, for example, a cable assembly may enter a building and provide lateral branches that are routed to locations within a building. An individual flexible NAP may be use to extend an optical network to a building or multiple NAPs may be used to distribute the network within a building. Tether length may be use to mitigate measurement errors and relaxes the need for absolute accuracy in placing NAPs.

Additional features and advantages of the invention are set out in the detailed description which follows, and will be readily apparent to those skilled in the art from that description or recognized by practicing the invention as described herein, including the detailed description which follows, the claims, as well as the appended drawings.

### BRIEF DESCRIPTION OF THE DRAWINGS

FIG. 1 is a perspective view of a cable assembly including a flexible NAP and a tether terminating in a multiport connection terminal.

FIG. 2A is a perspective view of a portion of a cable assembly including a distribution cable, a flexible NAP and a tether cable.

FIG. 2B is a perspective view of the flexible NAP portion of FIG. 2A shown bent around an arc that generically represents structure about which the cable assembly is routed or contacts.

FIG. 2C is a perspective view of the flexible NAP portion of FIG. 2A shown twisted.

FIG. 3 is a schematic diagram illustrating a cross-section of a bend performance optical fiber operable in accordance with an exemplary embodiment of the present invention.

FIG. 4 is a cross-sectional image of a microstructured bend performance optical fiber illustrating an annular hole-containing region comprised of non-periodically disposed holes.

### DETAILED DESCRIPTION OF THE INVENTION

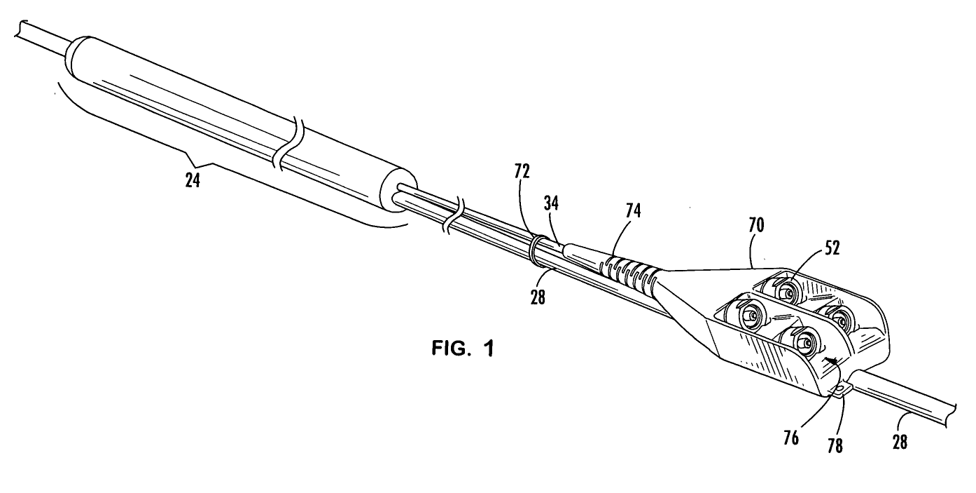

Referring to FIG. 1, the present invention provides embodiments of cable assemblies for both indoor and outdoor applications. Although only a portion of an entire cable assembly is shown, one example of a cable assembly of the present invention may include a plurality of the portions connected together by predetermined lengths of cable. In one embodiment, the cable assembly includes a distribution cable 28, a flexible NAP portion 24, also referred to herein as a “flexible closure”, substantially enclosing or encapsulating an access location along the distribution cable 28, and at least one tether 34 secured within or at the flexible NAP 24. The tether 34 terminates in a multiport terminal 70, but may, in alternative embodiments, terminate in splice ready optical fibers or one or more simplex, duplex or multi-fiber connectors. The multiport 70 provides access to one or more optical fibers optically connected to preterminated optical fibers of the distribution cable 28. The multiport 70 may be used to readily interconnect optical fibers of one or more connectorized drop cables with the preterminated fibers of the distribution cable 28 at a desired location within a network. The multiport 70 may be lashed to the distribution cable 28 using fasteners 72 at predetermined intervals along the length of the tether 34. Although four connector ports 52 are shown, any number of connector ports 52 may be accommodated. Connector ports 52 may include receptacles and/or fiber optic connectors. The multiport 70 defines a neck portion 74 that allows for additional flexibility. The multiport 70 also defines recesses 76 to protect the connector ports 52 from damage caused by impact. A molded tab 78 may be used both as a pulling grip and as a feature for securing the multiport 70 in a desired location. More than one tether 34 may be attached and be secured at either or both ends of the NAP 24.

The cable assemblies may be factory assembled or a flexible NAP may be added in the field. Factory prepared assemblies eliminate the need for first deploying a fiber optic distribution cable and then performing a mid-span access in the field. The tether 34 may be any fiber optic cable or a tubular body of any suitable cross sectional shape. As is well known in the optical fiber connecting art, optical fibers of the tether 34 and the distribution cable 28 may be spliced or otherwise connected together in any manner, such as by fusion or mechanical splicing, either individually or in mass. The tether 34 may have any predetermined length, for example, 15, 25, 50, 100 and 100+ feet, among others.

The distribution cable 28, tether 34 and the flexible NAP 24 may include flame retardant elements for indoor applications. The cable assemblies preferably meet or exceed the UL1666 flame test for riser applications, a test for flame propagation height of electrical and optical fiber cables installed vertically in shafts. The cable assemblies also preferably meet or exceed the NFPA 262 flame test, the standard method of test for flame travel and smoke of wires and cables for use in air-handling spaces. The cable assemblies may include OFNR interior cables and NAPs that do not contain electrically conductive components and which are certified for use in riser applications to prevent the spread of fire from floor to floor in an MDU and are ANSI/UL 1666-1997 compliant. The cable assemblies may include plenum cable that is laid in the plenum spaces of buildings typically used for air circulation in heating and air conditioning systems, typically between the structural ceiling and the dropped ceiling or under a raised floor. The plenum cables and their respective NAPs of the present invention meet or exceed the NFPA 90A standard, the standard for the installation of air conditioning and ventilating systems. The cable assemblies may include cables and NAPs that are LSZH (low smoke zero halogen) compliant and do not produce a Halogen gas when burned.

The overmold portion of the present invention can be formed by low pressure injection casting of reactive polymer liquids such as, but not limited to, polyurethanes. A typical polyurethane compound useful as an overmold compound comprises a two-part reactive mixture that can be metered together, mixed, and injected under low pressure into a mold. Part A typically comprises a prepolymer or quasi-prepolymer formed by the reaction of a polyol and a diisocynate. Part B typically comprises a mixture of polyol(s) and diols, triol, or amine chain extenders, along with other minor additives. A wide variety of polyols, diols, triols, amines, and diisocyanates are potentially useful in the molding compounds used for the overmold. The exact mixtures can be formulated to optimize a desired set of physical properties. Where such overmolds are deployed indoors, it is desirable that the flammability of the overmold be reduced through the addition of suitable flame retardants and fillers. The application of a flame retarding barrier material such as flame retardant tapes, spray on or paintable coatings, or other coverings such as woven glass mantles or composite glass polymer mantles can be used in addition to or in place of fire retardant additives. Useful flame retardant tapes are, for example, polyetherimide tapes supplied under the tradename Kapton and mica tapes.

Fire retarding molding compounds may include, for example, brominated additives such as Ethane-1,2-bis(pentabromophenyl) supplied as Albemarle Chemical as Saytex 8010, can be used alone or, more effectively, in combination with antimony oxide to interfere with free radical flame chemistry. Inert mineral fillers such as talc or calcium carbonate can be added in order to displace a portion of the overmold's flammable content. Properly selected fillers may also produce a desired effect of reducing or eliminating the tendency of burning PU to drip. High surface area fillers such as fumed silica are effective at reducing drip. In addition to displacing flammable content, hydrated mineral fillers such as aluminum trihydrate (ATH) or magnesium hydroxide (Mg(OH)2) decompose under heat to evolve water vapor. The evolved water vapor can help cool the burning polymer and dilute the flammable gases evolved during thermal decomposition. Furthermore, the evolving water vapor causes a cellular layer of material to form on the burning overmold surface. This cellular layer helps reduce flammability by creating a thermal insulation barrier at the surface. It is desirable that the cellular layer burns to produce a rigid char rather than ash. Elemental red phosphorous used in combination with metal hydrate fillers can improve the mechanical integrity of the char layer by promoting a more thermally stable carbon char. Zinc borate can also be used in combination with certain fillers to help form a vitreous char layer. Another useful method for reducing flammability of the overmold compound is through the addition of mixtures of alkaline salts and polyphosphate compounds such as ammonium polyphosphate. These materials can be used alone or in combination to other flame retardants.

Optionally, the composition of the present invention can also include a flame inhibiting silicone processing aid in an amount of from about 1 to about 20 weight percent of the hydrated inorganic filler. Suitable flame inhibiting silicone processing aids include polydimethylsiloxane gum dispersed on silica. These materials are described, for example, in U.S. Pat. No. 5,391,594 to Romenesko et al. One suitable flame inhibiting silicone processing aid is DC 4-7081, an acrylate functionalized ultra high molecular weight polydimethylsiloxane dispersed on fumed silica. This material is available from Dow Corning Corp. of Midland, Mich. Total content of flame retardants and fillers may range from about 10 to about 200 parts by weight per 100 parts by weight of base polymer. Filler addition may compromise desirable material physical properties such as impact resistance, tensile strength, elongation, and low temperature flexibility. Compound viscosity increase may also lead to processing difficulties. Surface modification of fillers with certain organofunctional agents can aide in their effectiveness by improving dispersion within the polymer compound, improving physical properties, and by keeping compound viscosity low during processing. Organic agents suitable for this purpose include fatty acids, vinylsilanes, aminosilanes, mercaptosilanes, epoxysilanes, and other organofunctional agents. One example of a surface treated hydrated mineral filler is Zerogen 51, a high purity magnesium hydroxide (99.6% pure) having a fatty acid surface treatment and an average particle size of 0.7 microns, supplied by J. M. Huber Corp., Macon, Ga.

In general, hydrated inorganic fillers suitable for use in the present invention include those which, upon thermal decomposition, release or produce water. One class of hydrated inorganic fillers that can be used in the overmold compound of the present invention is hydrated alkaline earth carbonates, such as hydrated magnesium carbonate and hydrated calcium carbonate. Hydrated mixed-metal carbonates, such as calcium magnesium carbonate, can also be used. Also, mixtures of the above metal carbonates, for example, mixtures of calcium carbonate and magnesium carbonate, can be used. Mixtures of the above metal carbonates and the above mixed-metal carbonates, for example, a mixture of calcium carbonate and calcium magnesium carbonate, are also suitable. The hydrated alkaline earth metal carbonates are preferably used as such; however, alternatively or additionally, hydrated alkaline earth metal carbonate precursors can be used. Suitable hydrated alkaline earth metal carbonate precursors are those materials which generate alkaline earth metal carbonates upon processing or upon exposure of the resulting composition to sufficient heat. Examples of such hydrated alkaline earth metal carbonate precursors include alkaline earth metal bicarbonates, for example, magnesium bicarbonate and calcium bicarbonate. Another class of suitable hydrated inorganic fillers is the alkaline earth hydroxides, such as calcium hydroxide and, preferably, magnesium hydroxide. Aluminum trihydrate and hydrated zinc borate are other suitable hydrated inorganic fillers that can be used in the compositions of the present invention. Combinations of these hydrated inorganic fillers can also be employed, and “hydrated inorganic filler”, as used herein, is meant to also include such combinations.

The overmold compound of the present invention, in addition to the above-described materials, can also include other materials. For example, the composition of the present invention can contain one or more conventional additives, such as inhibitors of oxidative, thermal, and ultraviolet light degradation, preferably at levels which do not adversely affect the physical and chemical characteristics of the composition. Suitable stabilizers include hindered phenols (e.g., Irganox 1010 available from Ciba-Geigy Corp. (Hawthorne, N.Y.)). Stabilizers are typically used in amounts of up to about 1 percent based on the total weight of the polymer blend. Ultraviolet light stabilizers, can be added in amounts of up to about 2 percent, based on the weight of the blend. The composition of the present invention can also include lubricants and release agents, colorants (including dyes and pigments), fibrous and particulate fillers, fibrous and particulate reinforcing materials, nucleating agents, and plasticizers to improve its handling and processing properties.

Other flame retarding methods may involve coating the overmold with a flame barrier material. This could be a tape or wrap that acts as a flame barrier. These could be glass, polyetherimide (Kapton tape—DuPont) or mica tape. Also, a coating could be applied like the NO-BURN material which can be sprayed on or in the form of a latex paint.

Riser cable types suitable for use in the present invention and available from Corning Cable Systems of Hickory, N.C. may include the FREEDM™ family of cables including ALTOS™, LST™ and Expanded LST™, Ribbon, ALTOS™ Ribbon, One, Fanout and LSZH, among others. These riser cables include various fiber counts and flame retardant components as described above. Plenum cable types suitable for use in the present invention and available from Corning Cable Systems of Hickory, N.C. may include FREEDM One™ and FREEDM™ Loose Tube Cables, among others. Cables may be plenum rated by using predetermined combinations of flame retardant PVC and PVDF materials, among others as described above.

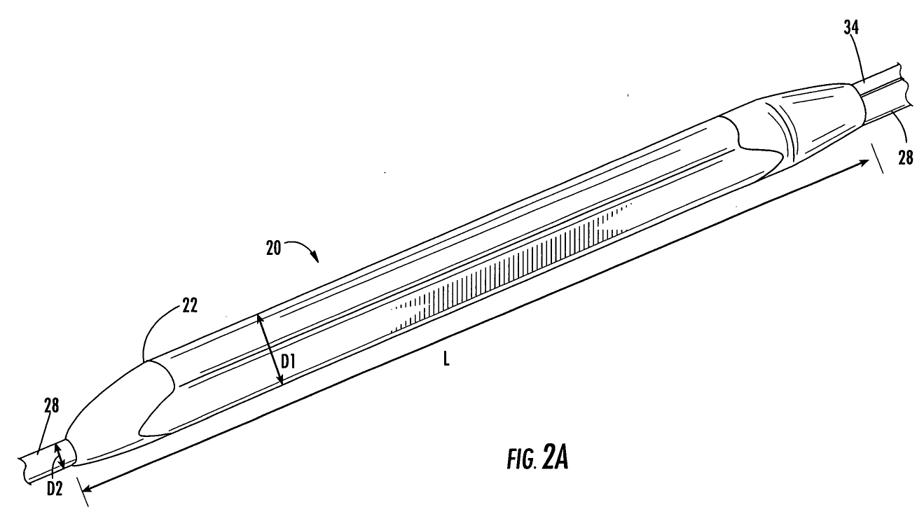

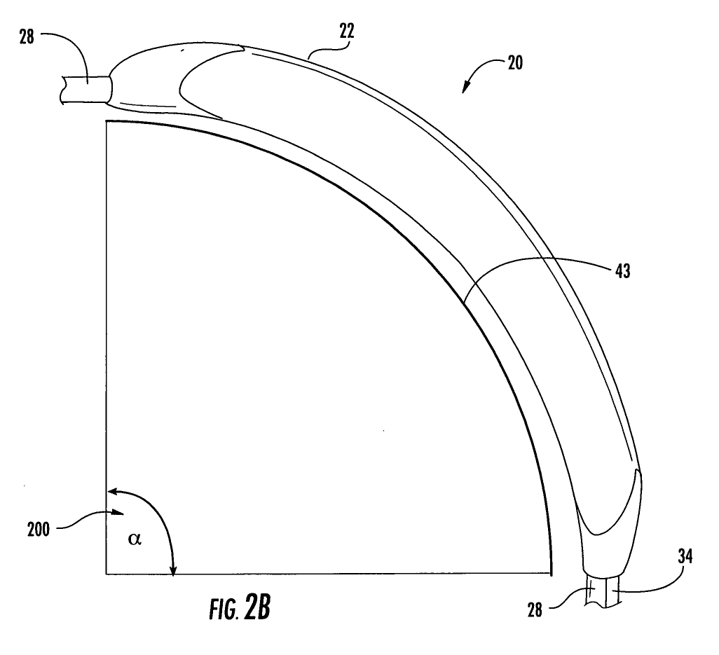

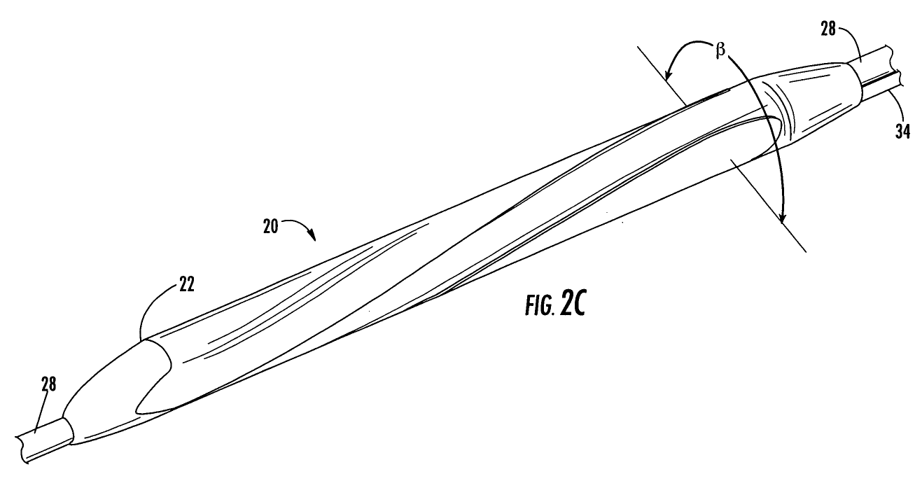

Referring to FIGS. 2A-C, a riser rated, plenum rated or other cable assembly portion 20 includes a flexible overmold 22 capable of bending about an angle α (FIG. 2B) and-or twisting about an angle β (FIG. 2C) in essentially any direction and about various bending radii, for example in single arcs or combination arcs defining S-shapes or U-shapes or other bent shapes. It is envisioned that the overmold 22 may be substitiuted for a heat shrink or other flexible member. The minimum bend radius can be defined as the radius below which an optical fiber or fiber-optic cable should not be bent because of mechanical or optical performance, for example, relating to optical attenuation. The minimum bend radius is of particular importance in the handling of fiber-optic cables, and it can vary with different cable designs and various types of optical fibers, such as conventional optical fibers and bend performance optical fibers, as described in more detail below. The minimum bend radius can be due to stresses associated with compression or tension acting on the cable, e.g., during installation procedures, for example, the cable may be bent around a sheave, wheel, drum or other arcuate surface generically shown at reference number 43 in FIG. 2B.

The flexible overmold 22 can be bent with a force about equal to the force required to bend the plenum, riser or other type of distribution cable 28 itself without the overmold 22 attached. Intrinsic properties of the overmold material itself contribute to the flexibility of the closure, and in some embodiments, its geometric shape and the positioning of optional strength components within. Optional strength components may provide a preferential bending in the flexible NAP portion of the assembly. The overmold 22 has a bending force ratio of about 1.0 to about 10.0, more preferably from about 1.0 to about 5.0, even more preferably from about 1.3 to about 3.4, wherein the bending force ratio is defined as the ratio of two forces, first, the force required to bend the flexible overmold 22 90 degrees about the minimum bend radius desired for the fiber optic cable, and divided by a second force being the force required to bend the same fiber optic cable 90 degrees about the minimum bend radius of that same cable. In the most preferred embodiments, the overmold 22 has a bending force ratio of about 1.0, implying that the force required to bend the flexible NAP portion is about equivalent to the force required to bend that same fiber optic cable without the overmold 22.

The overmold 22 has a bending range from about 0 degrees to about 360 degrees about a bend angle α at reference number 200. In typical installations, a bending range from about 0 degrees to about 180 degrees may be sufficient. Referring specifically to FIG. 2C, the overmold 22 can also be twisted without incurring damage to the closure structure or contents within and without compromising sealing. The overmold 22 can also be bent and twisted at the same time. The overmold 22 has an outer diameter D1 from about 0.5 to 5 inches, where functional diameters may be dictated by their deployment environment. The overmold 22 may have any desired diametral ratio (the ratio of the overmold outer diameter divided by the cable outer diameter D2), but is preferably about 2.0 or less, while diametral ratios of about 3.0 may also be practiced. Embodiments may have an aspect ratio (being the ratio of the length L of the closure 22 divided by the outer diameter D1) ranging from about 2 to about 30.

As described above, overmold material may be selected from suitable materials that include, but are not limited to, polyurethanes, silicones, thermoplastics and like materials that provide a modulus of elasticity of up to about 3.0 GPa, with a preferred range from about 0.001 to about 0.1 GPa, and an even more preferred modulus of elasticity of about 0.044 GPa. The overmold 22 preferably has a Poisson's ratio from about 0 to about 0.5, more preferably from about 0.2 to about 0.5, even more preferably from about 0.30 to about 0.5.

The flexible NAP portion may include a preferential bend to reduce the path length differences between the optical fibers terminated from the distribution cable and the optical fibers remaining in the distribution cable, thereby preventing breakage of the terminated optical fibers due to axial tension stresses induced by bending. A neutral axis may be provided in the Nap portion. Intrinsic material properties of the overmolded or heat shrink portion contribute to the flexible, yet sturdy, characteristic of the flexible NAP portion. Other NAP performance characteristics are described in co-pending U.S. patent application Ser. No. 11/268,345 filed Nov. 7, 2005 and titled “Flexible Optical Closure and other Flexible Optical Assemblies”, the contents of which are incorporated by reference.

An overmold may be formed by pour molding, high-pressure molding, injection molding, among others, by providing a flowable material about the cable access point, substantially encapsulating components and allowing the material to cure to define a flexible yet durable closure about the components. In various embodiments, the flexible NAP internal components can include various optical network components, taken alone or in combination, for example: one or more optical fibers, splices, splice holders, optical connectors, jumpers, fanouts, buffer or fanout tubes, strength members, splitters, active optical components such as switches, lasers, and routers, wireless components, antennae, electrical/copper connector cables, RFID tags, power devices or any other desired optical and electrical hardware or cable components.

In one exemplary and non-limiting molding example, the process may include: (i) arranging at least one optical component in, for example, a cavity made by a molding tool, die or die-casting; (ii) introducing a curable material in fluid form into the cavity, the fluid essentially flooding the cavity, penetrating interstices around and about the at least one optical component, and essentially covering the optical components; and (iii) curing the curable material within suitable curing conditions. Alternative exemplary processes may include vacuum and heat forming processes. Also, the overmolded portion can be applied by extruding a flexible closure material while pulling the assembly through a die. A flexible cover material, for example, a paper, plastic, tubing, or tape material, may cover at least a portion of the at least one optical component prior to applying the molding material so that the curable material will not contact the component in the covered area. The Nap portion may also include one or more pre-molded pieces that are added to the cable and fused or otherwise attached together to form a monolithic body. Curable means thermoplastic hardening, chemical additive curing, catalyst curing including energy curing as by heat or light energy, and phase changes, among others.

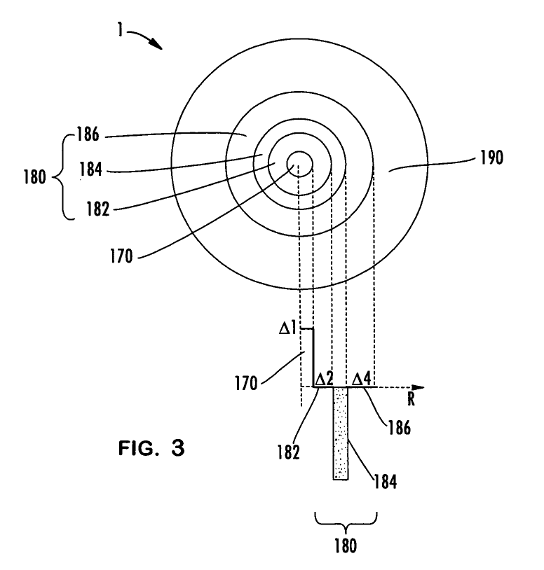

An indoor cable assembly of the present invention may include any optical fiber type including, but not limited to, single mode, multi-mode, bend performance fiber, bend optimized fiber and bend insensitive optical fiber. FIG. 3 illustrates a representation of a bend performance optical fiber 1 suitable for use in fiber optic cables, cables assemblies and other network components of the present invention. The fiber is advantageous in that allows cable assemblies to have aggressive bending while optical attenuation remains extremely low. As shown, bend performance optical fiber 1 is a microstructured optical fiber having a core region and a cladding region surrounding the core region, the cladding region comprising an annular hole-containing region comprised of non-periodically disposed holes such that the optical fiber is capable of single mode transmission at one or more wavelengths in one or more operating wavelength ranges. The core region and cladding region provide improved bend resistance, and single mode operation at wavelengths preferably greater than or equal to 1500 nm, in some embodiments also greater than about 1310 nm, in other embodiments also greater than 1260 nm. The optical fibers provide a mode field at a wavelength of 1310 nm preferably greater than 8.0 microns, more preferably between about 8.0 and 10.0 microns. In preferred embodiments, optical fiber disclosed herein is thus single-mode transmission optical fiber.

In some embodiments, the microstructured optical fibers disclosed herein comprises a core region disposed about a longitudinal centerline, and a cladding region surrounding the core region, the cladding region comprising an annular hole-containing region comprised of non-periodically disposed holes, wherein the annular hole-containing region has a maximum radial width of less than 12 microns, the annular hole-containing region has a regional void area percent of less than about 30 percent, and the non-periodically disposed holes have a mean diameter of less than 1550 nm.

By “non-periodically disposed” or “non-periodic distribution”, we mean that when one takes a cross-section (such as a cross-section perpendicular to the longitudinal axis) of the optical fiber, the non-periodically disposed holes are randomly or non-periodically distributed across a portion of the fiber. Similar cross sections taken at different points along the length of the fiber will reveal different cross-sectional hole patterns, i.e., various cross-sections will have different hole patterns, wherein the distributions of holes and sizes of holes do not match. That is, the holes are non-periodic, i.e., they are not periodically disposed within the fiber structure. These holes are stretched (elongated) along the length (i.e. in a direction generally parallel to the longitudinal axis) of the optical fiber, but do not extend the entire length of the entire fiber for typical lengths of transmission fiber.

For a variety of applications, it is desirable for the holes to be formed such that greater than about 95% of and preferably all of the holes exhibit a mean hole size in the cladding for the optical fiber which is less than 1550 nm, more preferably less than 775 nm, most preferably less than 390 nm. Likewise, it is preferable that the maximum diameter of the holes in the fiber be less than 7000 nm, more preferably less than 2000 nm, and even more preferably less than 1550 nm, and most preferably less than 775 nm. In some embodiments, the fibers disclosed herein have fewer than 5000 holes, in some embodiments also fewer than 1000 holes, and in other embodiments the total number of holes is fewer than 500 holes in a given optical fiber perpendicular cross-section. Of course, the most preferred fibers will exhibit combinations of these characteristics. Thus, for example, one particularly preferred embodiment of optical fiber would exhibit fewer than 200 holes in the optical fiber, the holes having a maximum diameter less than 1550 nm and a mean diameter less than 775 nm, although useful and bend resistant optical fibers can be achieved using larger and greater numbers of holes. The hole number, mean diameter, max diameter, and total void area percent of holes can all be calculated with the help of a scanning electron microscope at a magnification of about 800× and image analysis software, such as ImagePro, which is available from Media Cybernetics, Inc. of Silver Spring, Md., USA.

The optical fibers disclosed herein may or may not include germania or fluorine to also adjust the refractive index of the core and or cladding of the optical fiber, but these dopants can also be avoided in the intermediate annular region and instead, the holes (in combination with any gas or gases that may be disposed within the holes) can be used to adjust the manner in which light is guided down the core of the fiber. The hole-containing region may consist of undoped (pure) silica, thereby completely avoiding the use of any dopants in the hole-containing region, to achieve a decreased refractive index, or the hole-containing region may comprise doped silica, e.g. fluorine-doped silica having a plurality of holes.

In one set of embodiments, the core region includes doped silica to provide a positive refractive index relative to pure silica, e.g. germania doped silica. The core region is preferably hole-free. As illustrated in FIG. 3, in some embodiments, the core region 170 comprises a single core segment having a positive maximum refractive index relative to pure silica Δ₁ in %, and the single core segment extends from the centerline to a radius R₁. In one set of embodiments, 0.30%<Δ₁<0.40%, and 3.0 μm<R₁<5.0 μm. In some embodiments, the single core segment has a refractive index profile with an alpha shape, where alpha is 6 or more, and in some embodiments alpha is 8 or more. In some embodiments, the inner annular hole-free region 182 extends from the core region to a radius R₂, wherein the inner annular hole-free region has a radial width W12, equal to R2−R1, and W12 is greater than 1 μm. Radius R2 is preferably greater than 5 μm, more preferably greater than 6 μm. The intermediate annular hole-containing region 184 extends radially outward from R2 to radius R3 and has a radial width W23, equal to R3−R2. The outer annular region 186 extends radially outward from R3 to radius R4. Radius R4 is the outermost radius of the silica portion of the optical fiber. One or more coatings may be applied to the external surface of the silica portion of the optical fiber, starting at R4, the outermost diameter or outermost periphery of the glass part of the fiber. The core region 170 and the cladding region 180 are preferably comprised of silica. The core region 170 is preferably silica doped with one or more dopants. Preferably, the core region 170 is hole-free. The hole-containing region 184 has an inner radius R2 which is not more than 20 μm. In some embodiments, R2 is not less than 10 μm and not greater than 20 μm. In other embodiments, R2 is not less than 10 μm and not greater than 18 μm. In other embodiments, R2 is not less than 10 μm and not greater than 14 μm. Again, while not being limited to any particular width, the hole-containing region 184 has a radial width W23 which is not less than 0.5 μm. In some embodiments, W23 is not less than 0.5 μm and not greater than 20 μm. In other embodiments, W23 is not less than 2 μm and not greater than 12 μm. In other embodiments, W23 is not less than 2 μm and not greater than 10 μm.

Such fiber can be made to exhibit a fiber cutoff of less than 1400 nm, more preferably less than 1310 nm, a 20 mm macrobend induced loss at 1550 nm of less than 1 dB/turn, preferably less than 0.5 dB/turn, even more preferably less than 0.1 dB/turn, still more preferably less than 0.05 dB/turn, yet more preferably less than 0.03 dB/turn, and even still more preferably less than 0.02 dB/turn, a 12 mm macrobend induced loss at 1550 nm of less than 5 dB/turn, preferably less than 1 dB/turn, more preferably less than 0.5 dB/turn, even more preferably less than 0.2 dB/turn, still more preferably less than 0.01 dB/turn, still even more preferably less than 0.05 dB/turn, and a 8 mm macrobend induced loss at 1550 nm of less than 5 dB/turn, preferably less than 1 dB/turn, more preferably less than 0.5 dB/turn, and even more preferably less than 0.2 dB-turn, and still even more preferably less than 0.1 dB/turn.

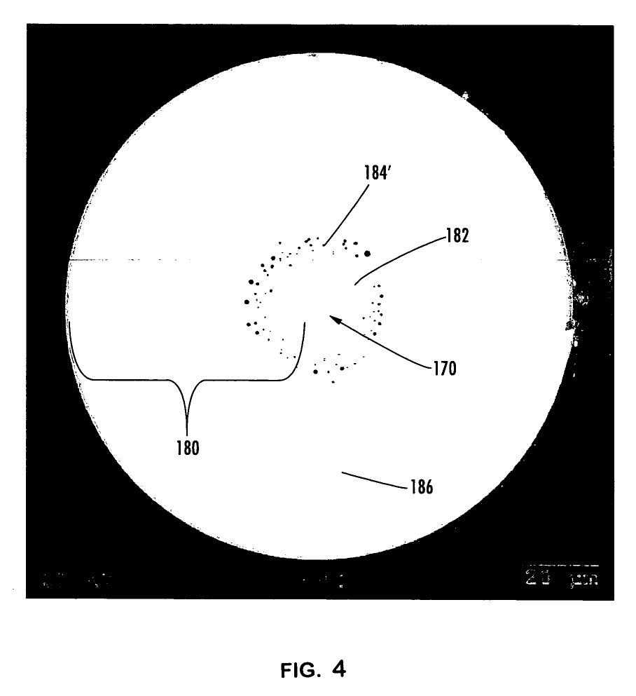

One example of a suitable fiber is illustrated in FIG. 4, and comprises a core region that is surrounded by a cladding region that comprises randomly disposed voids which are contained within an annular region spaced from the core and positioned to be effective to guide light along the core region. Other optical fibers and microstructured fibers may be used in the present invention. Additional description of microstructured fibers used in the present invention are disclosed in pending U.S. patent application Ser. No. 11/583,098 filed Oct. 18, 2006; and, Provisional U.S. patent application Ser. Nos. 60/817,863 filed Jun. 30, 2006; 60/817,721 filed Jun. 30, 2006; 60/841,458 filed Aug. 31, 2006; and 60/841,490 filed Aug. 31, 2006; all of which are assigned to Corning Incorporated; and incorporated herein by reference.

The present invention provides various embodiments of factory or field manufactured cable assemblies having predetermined NAPs that also serve as tether attach points. A NAP point may include one or more tethers and the tethers are used to extend the network to a location within reach of tether. In an MDU, for example, a cable assembly may enter a building and provide lateral branches that are routed to locations within a building. An individual flexible NAP may be use to extend an optical network to a building or multiple NAPs may be used to distribute the network within a building. Tether length may be use to mitigate measurement errors and relaxes the need for absolute accuracy in placing NAPs. Cable assemblies may be riser, plenum or LSZH rated compliant, among others.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. For example, other netowkr components may be used in combination with the assemblies of the present invention to extend a network within an MDU. Material, flame retardant and physical properties of the cable assemblies may be enhanced or relaxed based upon riser, plenum, LSZH or other requirements. The flexibility of the NAP portions of the assembly may be resilient or capable of holding a shape.

1. An indoor fiber optic cable assembly, comprising:
a flame retardant fiber optic distribution cable comprising at least one network access point at which at least one optical fiber is preterminated;
a flame retardant flexible closure substantially enclosing the at least one network access point; and
at least one tether secured about the flexible closure and comprising at least one optical fiber within that is optically connected with the at least one preterminated optical fiber of the distribution cable.

2. The indoor fiber optic cable assembly of claim 1, wherein the flexible closure is an overmold.

3. The indoor fiber optic cable assembly of claim 1, wherein the flexible closure is a heatshrink.

4. The indoor fiber optic cable assembly of claim 1, wherein the fiber optic distribution cable and the flexible closure are riser, plenum or low smoke zero halogen rated.

5. The indoor fiber optic cable assembly of claim 1, wherein the cable assembly includes a microstructured optical fiber.

6. The indoor fiber optic cable assembly of claim 1, wherein the distribution cable and the flexible closure are flame retarded using materials selected from the group consisting of fillers, tapes, spray on or paintable coatings, woven or composite glass polymer mantles, additives, brominated additives, inert mineral fillers, hydrated mineral fillers, mixtures of alkaline salts and polyphosphate compounds, flame inhibiting silicone processing and hydrated mixed-metal carbonates.

7. The indoor fiber optic cable assembly of claim 1, wherein the at least one tether is connectorized.

8. The indoor fiber optic cable assembly of claim 1, wherein the at least one tether is optically connected to a multi-port connection terminal.

9. The indoor fiber optic cable assembly of claim 1, wherein the cable assembly is deployed in a multi-dwelling unit.

10. An indoor fiber optic cable assembly, comprising:
a flame retardant fiber optic distribution cable comprising at least one network access point at which at least one optical fiber is preterminated;
a flexible closure covered with a flame-retarding barrier material so as to make the flexible closure flame retardant, the flexible closure substantially enclosing the at least one network access point; and
at least one tether secured about the flexible closure and comprising at least one optical fiber within that is optically connected with the at least one preterminated optical fiber of the distribution cable.

11. The indoor fiber optic cable assembly of claim 10, wherein the flexible closure is an overmold.

12. The indoor fiber optic cable assembly of claim 10, wherein the flexible closure is a heatshrink.

13. The indoor fiber optic cable assembly of claim 10, wherein the fiber optic distribution cable is riser, plenum or low smoke zero halogen rated.

14. The indoor fiber optic cable assembly of claim 10, wherein the cable assembly includes a microstructured optical fiber.

15. The indoor fiber optic cable assembly of claim 10, wherein the distribution cable is flame retarded using materials selected from the group consisting of fillers, tapes, spray on or paintable coatings, woven or composite glass polymer mantles, additives, brominated additives, inert mineral fillers, hydrated mineral fillers, mixtures of alkaline salts and polyphosphate compounds, flame inhibiting silicone processing and hydrated mixed-metal carbonates.

16. The indoor fiber optic cable assembly of claim 10, wherein the at least one tether is connectorized.

17. The indoor fiber optic cable assembly of claim 10, wherein the at least one tether is optically connected to a multi-port connection terminal.

18. The indoor fiber optic cable assembly of claim 10, wherein the cable assembly is deployed in a multi-dwelling unit.

19-20. (canceled)

21. A method of flame retarding a flexible network access point closure having an outside portion, comprising applying a flame retardant barrier material to the outside portion of the closure.

22. (canceled)

23. The method according to claim 21, wherein the flexible closure is an overmold.

24. The method according to claim 21, wherein the flexible closure is a heat shrink.
